(19) United States
(12) Patent Application Publication
(10) Pub. No.: US 2021/0333219 A1
(43) Pub. Date: Oct. 28, 2021

(54) METHOD OF DETERMINING DISTANCE BETWEEN PROBE AND WAFER HELD BY WAFER PROBE STATION

(71) Applicant: MPI Corporation, Hsinchu County (TW)

(72) Inventors: Frank FEHRMANN, Hsinchu County (TW); Chien-Hung CHEN, Hsinchu County (TW); Ching-Yang YANG, Hsinchu County (TW)

(21) Appl. No.: 16/858,711

(22) Filed: Apr. 27, 2020

(51) Int. Cl. G01N 21/95; G01C 3/02; G02B 21/00

(52) U.S. Cl. CPC G01N 21/9501; G02B 21/0004; G01C 3/02

(57) ABSTRACT

A method of determining a first distance between a probe and a wafer held by a wafer probe station includes adjusting a microscope at a specific magnification; moving the microscope perpendicularly relative to a chuck to focus on the chuck to obtain a clear image of the chuck; defining a specific position of the microscope after the clear image of the chuck is obtained; maintaining the specific magnification of the microscope and moving the microscope perpendicularly relative to the chuck from the specific position by a travelling distance to focus on the probe to obtain a clear image of the probe; and determining the travelling distance minus a thickness of a wafer to be placed on a side of the chuck facing to the microscope as the first distance between the probe and the wafer.

### BACKGROUND

### Technical Field

The present disclosure relates to methods of determining a distance between a probe and a wafer held by a wafer probe station. More particularly, the present disclosure relates to methods of determining a distance between a probe tip and a wafer held by a wafer probe station.

### Description of Related Art

As the demand for electronic devices has been increasing nowadays, the quality of the components of the electronic devices correspondingly becomes an important issue of the semiconductor industry. Apart from the improving technology of manufacture for the components, the accuracy of testing for the components has also become more important.

For example, wafer probe stations are in general used to test the quality of the wafers or dies in the semiconductor industry. Hence, the operational accuracy of wafer probe stations is undoubtedly concerned.

### SUMMARY

A technical aspect of the present disclosure is to provide a method of determining a first distance between a probe and a wafer held by a wafer probe station, which can obtain accurately the distance between the tip of the probe and the wafer in a simple and easy manner.

According to an embodiment of the present disclosure, a method of determining a first distance between a probe and a wafer held by a wafer probe station is provided. The method includes adjusting a microscope at a specific magnification; moving the microscope perpendicularly relative to a chuck to focus on the chuck to obtain a clear image of the chuck; defining a specific position of the microscope after the clear image of the chuck is obtained; maintaining the specific magnification of the microscope and moving the microscope perpendicularly relative to the chuck from the specific position by a travelling distance to focus on the probe to obtain a clear image of the probe; and determining the travelling distance minus a thickness of a wafer to be placed on a side of the chuck facing to the microscope as the first distance between the probe and the wafer.

In one or more embodiments of the present disclosure, the specific magnification is the maximum magnification of the microscope.

In one or more embodiments of the present disclosure, focusing on the probe includes focusing on a tip of the probe.

In one or more embodiments of the present disclosure, the method further includes determining the travelling distance of the microscope perpendicularly relative to the chuck from the specific position as a second distance between the probe and the chuck.

In one or more embodiments of the present disclosure, the probe includes a first portion and a second portion. The second portion is connected to a first end of the first portion and is located between the first portion and the chuck. The second portion has a length along a direction perpendicular to the chuck. A second end of the second portion away from the first end defines a tip. The focusing on the probe to obtain a clear image of the probe includes focusing on the first end to obtain a clear image of the first end. The method further includes determining the travelling distance minus the length of the second portion as a third distance between the tip and the chuck.

In one or more embodiments of the present disclosure, the method further includes determining the travelling distance minus the length of the second portion and the thickness of the wafer as a fourth distance between the tip and the wafer.

According to an embodiment of the present disclosure, a method of determining a first distance between a probe and a wafer held by a wafer probe station is provided. The method includes adjusting a microscope at a specific magnification; moving the microscope perpendicularly relative to the wafer to focus on the wafer to obtain a clear image of the wafer; defining a specific position of the microscope after the clear image of the wafer is obtained; maintaining the specific magnification of the microscope and moving the microscope perpendicularly relative to the wafer from the specific position by a travelling distance to focus on the probe to obtain a clear image of the probe; and determining the travelling distance as the first distance between the probe and the wafer.

In one or more embodiments of the present disclosure, the specific magnification is the maximum magnification of the microscope.

In one or more embodiments of the present disclosure, focusing on the probe includes focusing on a tip of the probe.

In one or more embodiments of the present disclosure, the probe includes a first portion and a second portion. The second portion is connected to a first end of the first portion and is located between the first portion and the wafer. The second portion has a length along a direction perpendicular to the wafer. A second end of the second portion away from the first end defines a tip. The focusing on the probe to obtain a clear image of the probe includes focusing on the first end to obtain a clear image of the first end. The method further includes determining the travelling distance minus the length of the second portion as a second distance between the tip and the wafer.

When compared with the prior art, the above-mentioned embodiments of the present disclosure have at least the following advantages:

(1) Since no extra tool is employed to determine the first distance between the probe and the wafer, the distance determining method provides a simple and easy way to obtain accurately the first distance between the probe, or the tip of the probe, and the wafer.

(2) According to the first distance between the probe, or the tip of the probe, and the wafer accurately determined, the user can move the chuck towards the probe until the wafer is precisely in contact with the tip of the probe in a safe manner. In this way, the accident that the wafer crashes with the probe when the chuck is moved towards the probe can be effectively avoided.

(3) Even if the tip of the probe is located substantially and vertically below the first end of the first portion and the tip of the probe is uneasy to be seen by the microscope, the sixth distance between the tip of the probe and the wafer can still be accurately determined. Similarly, according to the sixth distance between the probe, or the tip of the probe, and the wafer accurately determined, the user can move the chuck towards the probe until the wafer is precisely in contact with the tip of the probe in a safe manner. In this way, the accident that the wafer crashes with the probe when the chuck is moved towards the probe can be effectively avoided.

### BRIEF DESCRIPTION OF THE DRAWINGS

The disclosure can be more fully understood by reading the following detailed description of the embodiments, with reference made to the accompanying drawings as follows:

FIG. 1 is a schematic view of a wafer probe station according to an embodiment of the present disclosure;

FIG. 2 is a flow diagram of a method of determining a first distance between a probe and a wafer held by a wafer probe station according to an embodiment of the present disclosure;

FIG. 3 is a schematic view of the wafer probe station of FIG. 1, in which a wafer is placed on the chuck;

FIG. 4 is a schematic view of a wafer probe station according to another embodiment of the present disclosure, in which the probe includes a first portion and a second portion; and

FIG. 5 is a flow diagram of a method of determining a first distance between a probe and a wafer held by a wafer probe station according to another embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

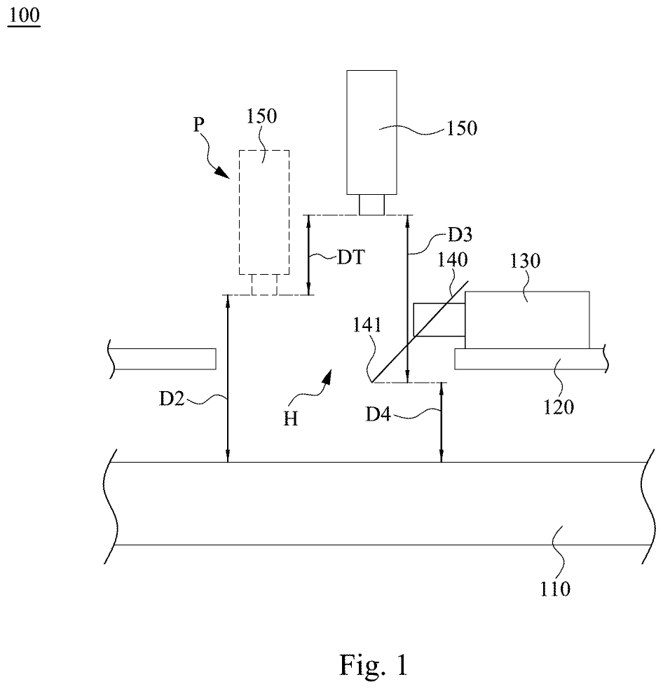

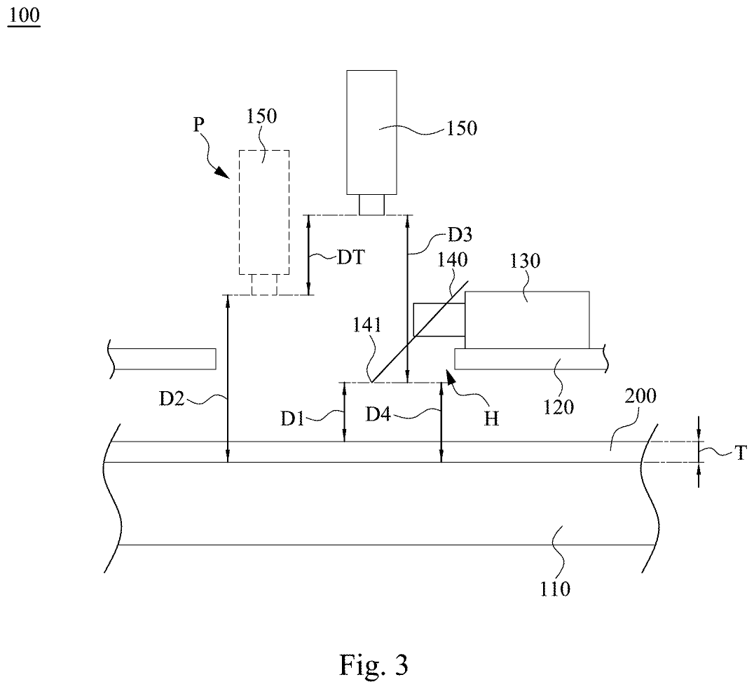

Reference is made to FIG. 1. FIG. 1 is a schematic view of a wafer probe station 100 according to an embodiment of the present disclosure. In this embodiment, as shown in FIG. 1, a wafer probe station 100 includes a chuck 110, a platen 120, a probe holder 130, at least one probe 140 and a microscope 150. The chuck 110 is practically rotatable and movable three dimensionally. The chuck 110 is configured to hold a wafer 200 (please refer to FIG. 3 for the wafer 200). The platen 120 is disposed above the chuck 110 and the probe holder 130 is mounted on a side of the platen 120 away from the chuck 110. The platen 120 has a through hole H. The probe 140 is held by the probe holder 130 such that the probe 140 can at least partially penetrate through the through hole H. The microscope 150 is disposed above the chuck 110 such that the probe 140 is at least partially located between the microscope 150 and the chuck 110. The microscope 150 is movable relative to the chuck 110 at least in a perpendicular manner.

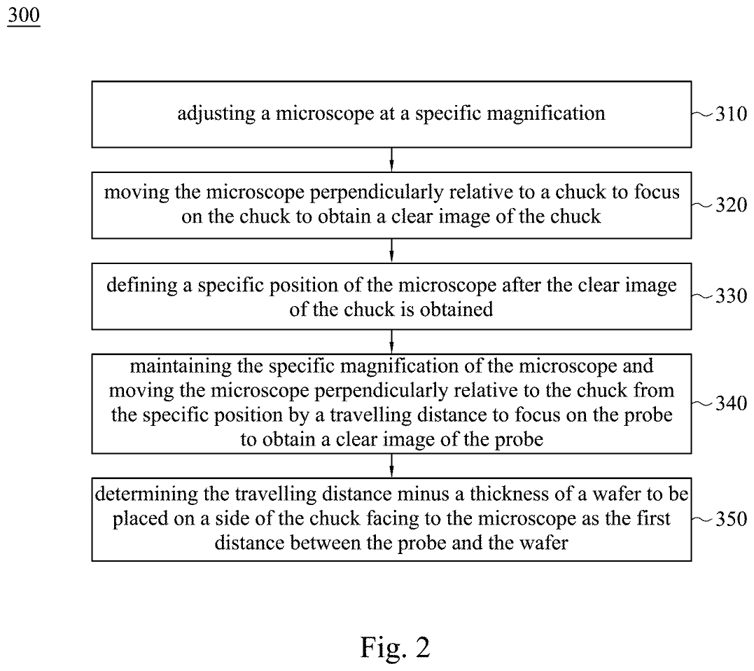

Reference is made to FIG. 2. FIG. 2 is a flow diagram of a method 300 of determining a first distance D1 between a probe 140 and a wafer 200 held by a wafer probe station 100 according to an embodiment of the present disclosure. As shown in FIG. 2, in this embodiment, the distance determining method 300 includes the following steps (it should be noted that the sequence of the steps and the sub-steps as mentioned below, unless otherwise specified, can all be adjusted upon the actual needs, or even executed at the same time or partially at the same time):

(1) Adjusting the microscope 150 at a specific magnification (Step 310). In practical applications, for example, the microscope 150 is adjusted to reach the maximum magnification. At the maximum magnification, the range of the depth of focus (DOF) of the microscope 150 is the narrowest, which means a clear image can be obtained by the microscope 150 in the most accurate manner at the maximum magnification. In other embodiments, the microscope 150 can be adjusted to use other values of magnification according to the actual conditions. However, this does not intend to limit the present disclosure.

(2) Moving the microscope 150 perpendicularly relative to the chuck 110 to focus on the chuck 110 to obtain a clear image of the chuck 110 (Step 320). After the microscope 150 is adjusted to reach the maximum magnification as mentioned above, the microscope 150 is moved perpendicularly relative to the chuck 110 until the image of the chuck 110 is clearly focused by the microscope 150. In other words, the microscope 150 is moved towards the chuck 110 or away from the chuck 110 until the image of the chuck 110 is clearly focused by the microscope 150.

(3) Defining a specific position P of the microscope 150 after the clear image of the chuck 110 is obtained by the microscope 150 (Step 330). At the point that the image of the chuck 110 is clearly focused by the microscope 150, i.e., the clear image of the chuck 110 is obtained, the position of the microscope 150 with the chuck 110 in focus is particularly defined as the specific position P. When the microscope 150 is positioned at the specific position P, a second distance D2 between the microscope 150 and the chuck 110 is of a specific value and defined by the microscopes objective working distance. In contrast, when the image of the chuck 110 obtained by the microscope 150 is clear, it can be understood that the second distance D2 between the microscope 150 and the chuck 110 is of the specific value and is the same as the microscopes objective working distance. Moreover, since the range of the depth of focus (DOF) of the microscope 150 is the narrowest at the maximum magnification as mentioned above, the specific value of the second distance D2 between the microscope 150 and the chuck 110 is accurate. As shown in FIG. 1, the microscope 150 located at the specific position P is presented by hidden lines.

(4) Maintaining the specific magnification to be the maximum magnification of the microscope 150 and moving the microscope 150 perpendicularly relative to the chuck 110 from the specific position P by a travelling distance DT to focus on the probe 140 to obtain a clear image of the probe 140 (Step 340). When the image of the probe 140 obtained by the microscope 150 is clear, a third distance D3 between the microscope 150 and the probe 140 is of the same specific value as the second distance D2 between the microscope 150 and the chuck 110 when the microscope 150 is positioned at the specific position P as mentioned above. As a result, a fourth distance D4 between the probe 140 and the chuck 110 can be determined to be equal to the travelling distance DT after the clear image of the probe 140 is obtained by the microscope 150. As shown in FIG. 1, the microscope 150 located from the specific position P by the travelling distance DT is presented by solid lines. In practical applications, the step of focusing on the probe 140 includes focusing on a tip 141 of the probe 140. In other words, the fourth distance D4 is the distance between the tip 141 of the probe 140 and the chuck 110.

It is worth to note that, the Step 340 and the Step 320 are practically interchangeable. This means, the probe 140 can be focused to obtain a clear image of the probe 140 first before a clear image of the chuck 110 is obtained, or the chuck 110 can be focused to obtain a clear image of the chuck 110 first before a clear image of the probe 140 is obtained, according to the actual situation.

(5) Determining the travelling distance DT minus a thickness T of a wafer 200 to be placed on a side of the chuck 110 facing to the microscope 150 as the first distance D1 between the probe 140 and the wafer 200 (Step 350), as shown in FIG. 3. FIG. 3 is a schematic view of the wafer probe station 100 of FIG. 1, in which a wafer 200 is placed on the chuck 110. In this embodiment, after the fourth distance D4 between the probe 140 and the chuck 110 is accurately determined to be the travelling distance DT of the microscope 150 as mentioned above, the wafer 200 can be placed on the chuck 110 and the difference between the travelling distance DT and a thickness T of the wafer 200 can be determined as the first distance D1 between the tip 141 of the probe 140 and the wafer 200.

Since no extra tool is employed to determine the first distance D1 between the probe 140 and the wafer 200, the distance determining method 300 provides a simple and easy way to obtain accurately the first distance D1 between the probe 140, or the tip 141 of the probe 140, and the wafer 200.

Moreover, according to the first distance D1 between the probe 140, or the tip 141 of the probe 140, and the wafer 200 accurately determined, the user can move the chuck 110 towards the probe 140 until the wafer 200 is precisely in contact with the tip 141 of the probe 140 in a safe manner. In this way, the accident that the wafer 200 crashes with the probe 140 when the chuck 110 is moved towards the probe 140 can be effectively avoided.

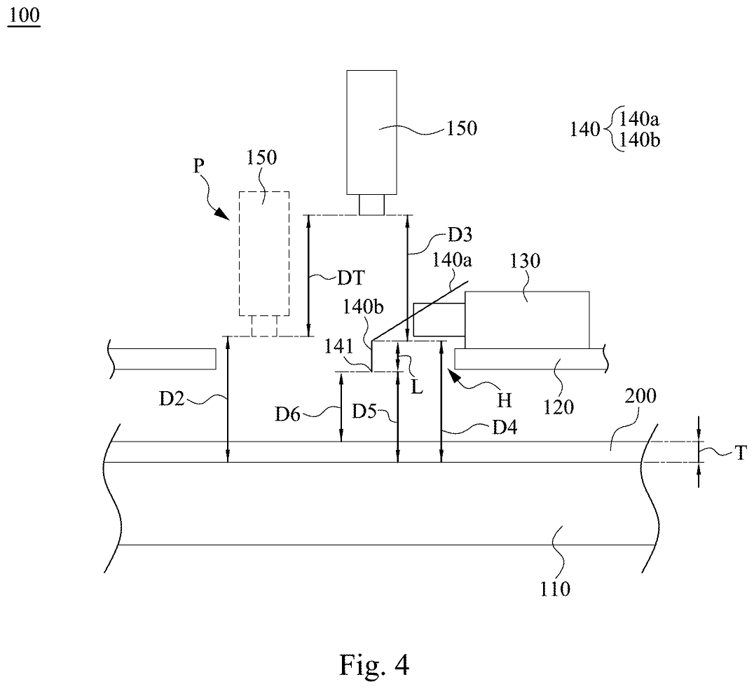

Reference is made to FIG. 4. FIG. 4 is a schematic view of a wafer probe station 100 according to another embodiment of the present disclosure, in which the probe 140 includes a first portion 140a and a second portion 140b. In this embodiment, as shown in FIG. 4, the probe 140 includes a first portion 140a and a second portion 140b. The second portion 140b is connected to a first end of the first portion 140a. The second portion 140b is located between the first portion 140a and the chuck 110. The second portion 140b has a length L along a direction Y. In this embodiment, the direction Y is substantially perpendicular to the chuck 110. In practice, the direction Y is a vertical direction. In other words, the second portion 140b is a vertical portion of the probe 140. Moreover, a second end of the second portion 140b away from the first end defines the tip 141 of the probe 140. It is worth to note that the step of focusing on the probe 140 to obtain a clear image of the probe 140 as mentioned above further includes focusing on the first end of the first portion 140a to obtain a clear image of the first end. Afterwards, the distance determining method 300 further includes the step of determining the fourth distance D4 (which is equal to the travelling distance DT) minus the length L of the second portion 140b as a fifth distance D5 between the tip 141 of the probe 140 and the chuck 110 (Step 360).

Subsequently after a wafer 200 is placed on the chuck 110 for testing, in this embodiment, the distance determining method 300 further includes the step of determining the fifth distance D5 (which is equal to the travelling distance DT minus the length L of the second portion 140b as mentioned above) minus the thickness T of the wafer 200 as a sixth distance D6 between the tip 141 of the probe 140 and the wafer 200 (Step 370). In other words, even if the tip 141 of the probe 140 is substantially located vertically below the first end of the first portion 140a and the tip 141 of the probe 140 is uneasy to be seen by the microscope 150, the sixth distance D6 between the tip 141 of the probe 140 and the wafer 200 can still be accurately determined. Similarly, according to the sixth distance D6 between the tip 141 of the probe 140 and the wafer 200 accurately determined, the user can move the chuck 110 towards the probe 140 until the wafer 200 is precisely in contact with the tip 141 of the probe 140 in a safe manner. In this way, the accident that the wafer 200 crashes with the probe 140 when the chuck 110 is moved towards the probe 140 can be effectively avoided.

Please be noted that in other embodiments, however, the second portion 140b as shown in FIG. 4 can be inclined at an angle, i.e., the direction Y is not a vertical direction anymore. In this situation, the second portion 140b can be regarded as the inclined configuration of the probe 140 of FIG. 3, and relevant procedures as mentioned above can be carried out.

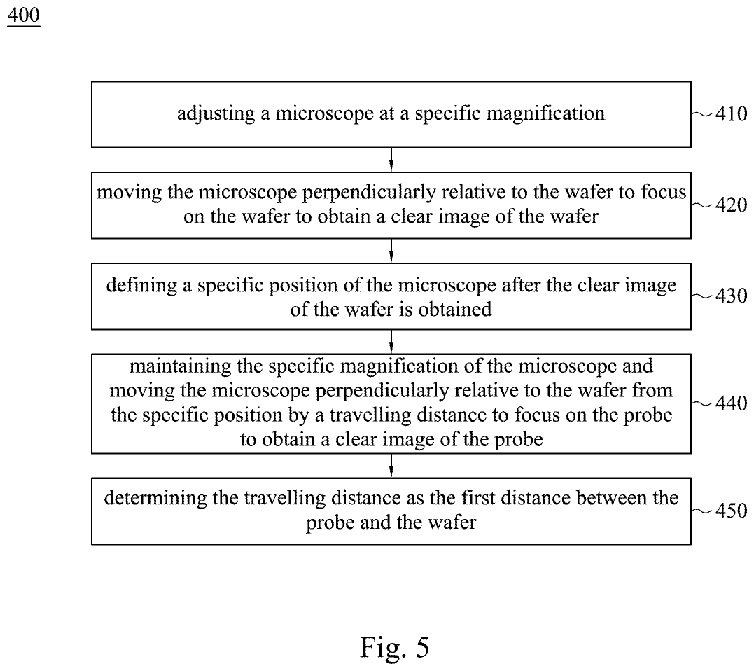

Reference is made to FIG. 5. FIG. 5 is a flow diagram of a method 400 of determining a first distance D1 between a probe 140 and a wafer 200 held by a wafer probe station 100 according to another embodiment of the present disclosure. The main difference between the distance determining method 400 and the distance determining method 300 is that in the distance determining method 400, the first distance D1 between the probe 140 and the wafer 200 is directly determined with the wafer 200 already placed on the chuck 110 to be focused by the microscope 150. FIG. 3 can be taken as the reference of configuration with regard to the distance determining method 400.

In details, in this embodiment as shown in FIG. 5, the distance determining method 400 includes the following steps (it should be noted that the sequence of the steps and the sub-steps as mentioned below, unless otherwise specified, can all be adjusted upon the actual needs, or even executed at the same time or partially at the same time):

(1) Adjusting the microscope 150 at a specific magnification (Step 410). Similarly, for the sake of accuracy, the microscope 150 is adjusted to reach the maximum magnification.

(2) Moving the microscope 150 adjusted with the maximum magnification perpendicularly relative to the wafer 200 to focus on the wafer 200 to obtain a clear image of the wafer 200 (Step 420).

(3) Defining a specific position P of the microscope 150 after the clear image of the wafer 200 is obtained (Step 430).

(4) Maintaining the specific magnification to be the maximum magnification of the microscope 150 and moving the microscope 150 perpendicularly relative to the wafer 200 from the specific position P by a travelling distance DT to focus on the probe 140 to obtain a clear image of the probe 140 (Step 440).

Similarly, it is worth to note that, the Step 440 and the Step 420 are practically interchangeable. This means, the probe 140 can be focused to obtain a clear image of the probe 140 first before a clear image of the wafer 200 is obtained, or the wafer 200 can be focused to obtain a clear image of the wafer 200 first before a clear image of the probe 140 is obtained, according to the actual situation.

(5) Determining the travelling distance DT as the first distance D1 between the probe 140 and the wafer 200 (Step 450).

Similarly, since no extra tool is employed to determine the first distance D1 between the probe 140 and the wafer 200, the distance determining method 400 provides a simple and easy way to obtain accurately the first distance D1 between the probe 140, or the tip 141 of the probe 140, and the wafer 200.

Moreover, according to the first distance D1 between the probe 140, or the tip 141 of the probe 140, and the wafer 200 accurately determined, the user can move the chuck 110 towards the probe 140 until the wafer 200 is precisely in contact with the tip 141 of the probe 140 in a safe manner. In this way, the accident that the wafer 200 crashes with the probe 140 when the chuck 110 is moved towards the probe 140 can be effectively avoided.

In conclusion, when compared with the prior art, the aforementioned embodiments of the present disclosure have at least the following advantages:

(1) Since no extra tool is employed to determine the first distance between the probe and the wafer, the distance determining method provides a simple and easy way to obtain accurately the first distance between the probe, or the tip of the probe, and the wafer.

(2) According to the first distance between the probe, or the tip of the probe, and the wafer accurately determined, the user can move the chuck towards the probe until the wafer is precisely in contact with the tip of the probe in a safe manner. In this way, the accident that the wafer crashes with the probe when the chuck is moved towards the probe can be effectively avoided.

(3) Even if the tip of the probe is located substantially and vertically below the first end of the first portion and the tip of the probe is uneasy to be seen by the microscope, the sixth distance between the tip of the probe and the wafer can still be accurately determined. Similarly, according to the sixth distance between the probe, or the tip of the probe, and the wafer accurately determined, the user can move the chuck towards the probe until the wafer is precisely in contact with the tip of the probe in a safe manner. In this way, the accident that the wafer crashes with the probe when the chuck is moved towards the probe can be effectively avoided.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A method of determining a first distance between a probe and a wafer held by a wafer probe station, the method comprising:
adjusting a microscope at a specific magnification;
moving the microscope perpendicularly relative to a chuck to focus on the chuck to obtain a clear image of the chuck;
defining a specific position of the microscope after the clear image of the chuck is obtained;
maintaining the specific magnification of the microscope and moving the microscope perpendicularly relative to the chuck from the specific position by a travelling distance to focus on the probe to obtain a clear image of the probe; and
determining the travelling distance minus a thickness of a wafer to be placed on a side of the chuck facing to the microscope as the first distance between the probe and the wafer.

2. The distance determining method of claim 1, wherein the specific magnification is the maximum magnification of the microscope.

3. The distance determining method of claim 1, wherein focusing on the probe comprises:
focusing on a tip of the probe.

4. The distance determining method of claim 1, further comprising:
determining the travelling distance of the microscope perpendicularly relative to the chuck from the specific position as a second distance between the probe and the chuck.

5. The distance determining method of claim 1, wherein the probe comprises a first portion and a second portion, the second portion is connected to a first end of the first portion and is located between the first portion and the chuck, the second portion has a length along a direction perpendicular to the chuck, a second end of the second portion away from the first end defines a tip, the focusing on the probe to obtain a clear image of the probe comprises:
focusing on the first end to obtain a clear image of the first end,
wherein the method further comprises:
determining the travelling distance minus the length of the second portion as a third distance between the tip and the chuck.

6. The distance determining method of claim 5, further comprising:
determining the travelling distance minus the length of the second portion and the thickness of the wafer as a fourth distance between the tip and the wafer.

7. A method of determining a first distance between a probe and a wafer held by a wafer probe station, the method comprising:
adjusting a microscope at a specific magnification;
moving the microscope perpendicularly relative to the wafer to focus on the wafer to obtain a clear image of the wafer;
defining a specific position of the microscope after the clear image of the wafer is obtained;
maintaining the specific magnification of the microscope and moving the microscope perpendicularly relative to the wafer from the specific position by a travelling distance to focus on the probe to obtain a clear image of the probe; and
determining the travelling distance as the first distance between the probe and the wafer.

8. The distance determining method of claim 7, wherein the specific magnification is the maximum magnification of the microscope.

9. The distance determining method of claim 7, wherein focusing on the probe comprises:
focusing on a tip of the probe.

10. The distance determining method of claim 7, wherein the probe comprises a first portion and a second portion, the second portion is connected to a first end of the first portion and is located between the first portion and the wafer, the second portion has a length along a direction perpendicular to the wafer, a second end of the second portion away from the first end defines a tip, the focusing on the probe to obtain a clear image of the probe comprises:
focusing on the first end to obtain a clear image of the first end,
wherein the method further comprises:
determining the travelling distance minus the length of the second portion as a second distance between the tip and the wafer.
